(19) United States
(12) Patent Application Publication
(10) Pub. No.: US 2013/0318436 A1
(43) Pub. Date: Nov. 28, 2013

(54) SYSTEM AND INFRASTRUCTURE FOR DISPLAYING DIGITAL TEXT DOCUMENTS ON A MOBILE DEVICE

(71) Applicant: Andreas Steinhauser, Berlin (DE)

(72) Inventor: Andreas Steinhauser, Berlin (DE)

(73) Assignee: TXTR GmbH, Berlin (DE)

(21) Appl. No.: 13/880,385

(22) PCT Filed: Oct. 20, 2011
(86) PCT No.: PCT/IB2011/003062

§ 371 Date: Aug. 13, 2013

(30) Foreign Application Priority Data
Oct. 22, 2010 (DE) 10 2010 056 093.6

(51) Int. Cl. G06F 17/21

(52) U.S. Cl. CPC G06F 17/211
USPC 715/249

(57) ABSTRACT

Presented is a comprehensive infrastructure for easy procurement, licensing, rendering and display of digital text documents. Basic principle of the invention and the provided infrastructure is to divide the execution of E-reading related processes such as procurement of documents, licensing, rendering and display between two different devices, a mobile unit on one hand and a base station on the other hand. In particular, a cost and energy-efficient variant of an electronic device is described that serves as mobile unit that is especially designed for the display of digital text documents within the provided infrastructure.

The present invention describes a system for displaying digital text documents on a mobile device. It claims the priority of german application no.102010056093.6.

Presented is a comprehensive infrastructure for easy procurement, licensing, rendering and display of digital text documents. Basic principle of the invention and the provided infrastructure is to divide the execution of E-reading related processes such as procurement of documents, licensing, rendering and display between two different devices, a mobile unit on one hand and a base station on the other hand. In particular, a cost and energy-efficient variant of an electronic device is described that serves as mobile unit that is especially designed for the display of digital text documents within the provided infrastructure.

### BACKGROUND OF THE INVENTION

### Field of the Invention and Related Art

Mobile electronic reading devices, so-called E-Readers have been available on the market for some time. Designs and implementations of E-Reader technology are manifold considering e.g. the size of the device, display technology and memory capabilities. In general, E-Readers feature sufficient memory to store several documents. They are equipped with various interfaces to other electronic devices, e.g. USB or radio. In addition, they offer a number of menu- and interaction-features to the user.

Alternatively, conventional mobile devices such as notebooks or smartphones can be used as E-Readers by installing appropriate software. Text documents are for example available for sale in Internet stores or can be transferred from another electronic device, e.g. a PC, via the mentioned interfaces.

In most cases, digital text documents (esp. books) are protected by copyrights or other IP laws. In order to prevent infringement, users of digital text documents have to be authorized. They can for example obtain a unique user ID. Copyrighted digital text documents that are procured under a certain user ID (e.g. Adobe ID) can only be opened on a limited number of devices that are linked to the same user ID. In a digital rights management (DRM) system digital content is encrypted before it is delivered to the user. Before the user can read the document it has to be licensed and then decrypted. This process is referred to as “fulfilment”. License and key for decryption are linked to the unique user ID.

After fulfilling a document it needs to be converted (rendered) into a format that is readable by a display. Usually text documents (pdf or e-pub format) are converted to image files such as gif or bmp that can be directly displayed.

The processes of fulfilling and rendering are carried out on the E-Reader. Those processes are memory- and time- as well as energy-consuming.

### Disadvantages of Related Art

### Lifetime, Cost and Price:

The processes described above of licensing and rendering documents consume time and energy, thus limiting the overall performance capacity of the E-Reader. Furthermore, adequate processing (CPU) capacity and sufficient working memory is required. For these purposes appropriate hardware and well-engineered software have to be applied. Number and features of those components significantly influence the cost of a device, thus affecting the price at which an E-Reader can be marketed. High market prices however deter potential customers from buying an E-Reader.

### Quality of Reading:

Using conventional mobile devices (e.g. notebooks or smartphones) for reading electronic books and text documents is a cheap alternative. However, the display of such devices usually is of insufficient quality or size for reading several documents or pages at once. Furthermore those devices require a lot of energy not only for the display but also other processes carried out on the device. Battery lifetime in these cases is usually too short to read a whole book indepentently from external energy sources. It is therefore beneficial to display text on a display that is especially designed for the purpose of reading and of high reading quality and at the same time low energy consumption.

### Usability:

Many E-Readers offer extensive functionalities, such as menu navigation and user interaction. For the sake of reading those functions are dispensable, to some extend they might even confuse the users. Besides they consume a considerable amount of energy and memory capacity.

### SUMMARY OF THE INVENTION

Based on the assumed state-of-the-art and the related disadvantages of existing technological solutions, the presented invention aims at providing an E-Reader that can be manufactured at lower costs and thus marketed at a lower price. At the same time the provided mobile unit will be easier to use and highly efficient in terms of energy consumption and memory requirements. This is accomplished by providing a mobile unit, that is a novel mobile electronic device that features a minimum of necessary components and functionality. This mobile unit is part of a comprehensive infrastructure: Functions that do not directly conduce to the purpose of reading but that are necessary, such as procurement, licensing and rendering of text documents, become outsourced to third party devices, that is a base station. Through this, a comprehensive infrastructure for easy procurement and display of digital text documents is introduced.

### BRIEF DESCRIPTION OF THE DRAWINGS

Embodiments of the invention are illustrated in the following figures. It is noted that drawings represent examples only and do not limit the scope of the invention.

FIG. 1 depicts the presented comprehensive infrastructure of mobile unit and base station that enables the procurement, rendering and display of digital text documents.

FIG. 2 illustrates the basic composition of the presented mobile unit featuring a minimum of components that serve for the reception and display of pre-rendered images. In the shown configuration the mobile unit can be produced at low costs and operated at low energy consumption. The interface to the base station is realized in a wireless manner, e.g. bluetooth radio.

FIG. 3 illustrates the document flow through the provided infrastructure. Via the base station a web shop can be accessed on the Internet in order to buy a book. The base station provides for the licensing and rendering of the text document and the transfer of pre-rendered images to the mobile unit, in this case via a bluetooth radio interface. The user controlls those processes through the User Interfaces of mobile unit and base station.

FIG. 4 represents an exemplary diagram of operations carried out before displaying a book on the mobile unit. On the base station a book can be chosen from a booklist to be read on the mobile unit. When a connection to the mobile unit has been built up (in this case via bluetooth) the user can chose to download the book to the mobile unit. If no book is on the device the chosen book is stored onto the memory. If there is already a book on the device the user is asked whether to overwrite the memory and store a new book.

FIG. 5 shows an exemplary flow of operations carried out on the mobile unit when reading and paging through a text. The two paging keys can offer different paging speed. Fast paging is initiated when a key is held for a certain time.

FIG. 6 illustrates an exemplary process flow of establishing a radio (bluetooth) connection to the base station. The bluetooth interface of the mobile device is initiated when pressing a specified key or combination of keys. If the device is already paired with the base station the connection is working. Otherwise, a pairing process between base station and mobile unit has to be initiated in order to establish a working connection to realize book downloads etc.

### DETAILED DESCRIPTION OF THE INVENTION

The present invention provides a comprehensive infrastructure for displaying digital text documents on a mobile device. According to claim 1, the provided system comprises the following components:
mobile unit, comprising
   display
   memory
   microcontroller/display-controller
   interface to the base station
   energy source
base station, comprising at least
   data interface
   data storage
   data processing unit
   interface to the mobile unit
   energy source

Basic principle of the invention and the provided system according to claim 1 is to divide the execution of E-Reader related processes such as procurement of documents, licensing, rendering and display between two different devices, a mobile unit on one hand and a base station on the other hand. A novel mobile device comes into operation as mobile unit. This mobile device is especially designed for the display of text while featuring a minimum of energy consumption and memory requirement.

Dividing the execution of E-Reader related processes such as procurement of documents, licensing, rendering and display between two different devices, leads to many advantages in comparison to the state-of-the-art.

The presented mobile unit comprises only a minimum of components with low energy consumption and low production costs. The display unit is optimized for the display of text, other functions that are dispensable for reading text are not integrated. In this way no energy is wasted to such functions. Doing so, battery lifetime available for reading can be tremendously extended.

The base station that is necessary to complete the provided infrastructure for the procurement and display of digital text documents can be a commonly used electronic device. It needs to have an interface in order to receive digital text documents. This can be any type of wired or wireless link to another electronic device from which documents can be sent. Especially a connection to a communication network (such as the internet) is desired. An internet connection enables the use of webshops and other platforms from which documents can be bought or otherwise obtained. Documents received by the base station in any of the specified ways can be stored on the base station.

The base station is capable of executing the necessary operations of fulfilling and rendering documents so that they can be accessed by the designated user.

As a matter of course the base station needs to feature an energy source which can be any commonly available.

The base station can also be represented by a mobile device. Furthermore, electronic devices that are already at the user's hand, e.g. a smartphone or tablet PC, that are capable of receiving, storing, processing and sending documents, can function as base station in order to carry out the provided system.

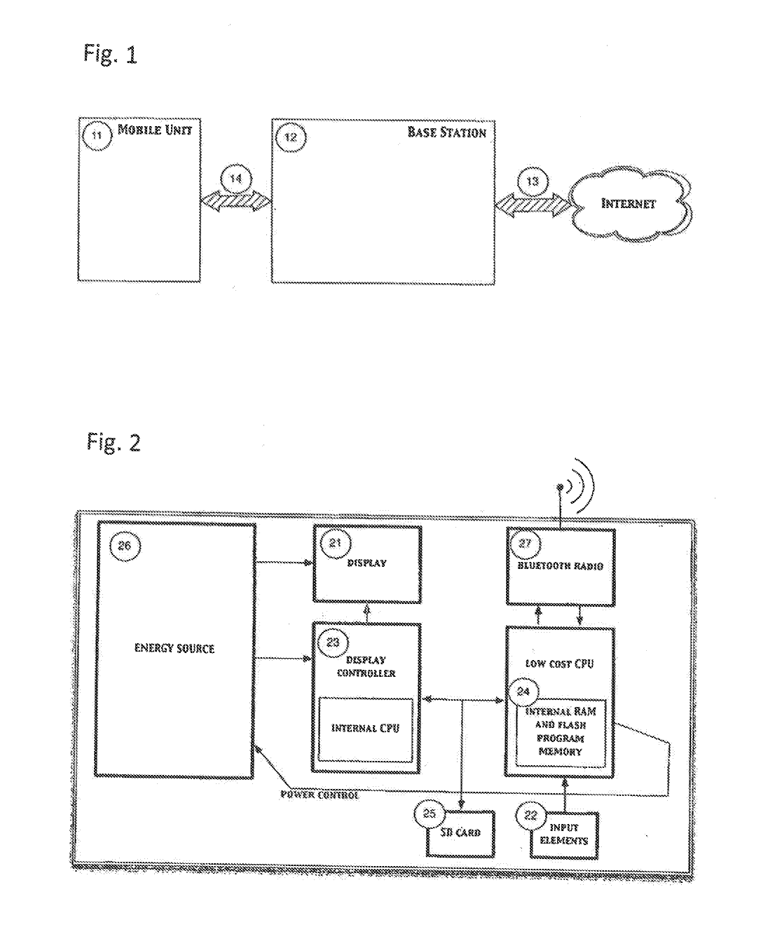

FIG. 1 represents the basic architecture of the provided system.

The mobile unit (11) serves for the display of single pages of a text document. Therefore it contains a display and a display controlling unit (microcontroller), a data storage (memory), an interface to the base station, and an energy source. A precise description of the components that are contained in the mobile unit is given below (FIG. 2).

The base station (12) is capable of receiving text documents via its data interface from the Internet (13) and sending documents via the data interface to the mobile unit (14). The base station features capacities for processing and storing data. Documents can be received and stored in various formatting, for example as pdf, epub or text files. Before sending a document to the mobile unit it has to be rendered into a displayable format. Typically these are image formats. According to available storage capacities gif—(graphics interchange format), png—(portable network graphics) or bmp—(bitmap) files can be used. To accelerate data transfer from base station to mobile unit the image files can be additionally compressed. This also reduces to memory necessary to store the data on the mobile unit. To enhance security data can also be encrypted before the transfer.

Personal Computers (PCs) or smartphones, amongst others, that offer the mentioned features can work as base station within the provided system.

In order to implement the presented system, an existing infrastructure of Web shops and electronic devices capable of connecting as well to those Web shops as to an E-Reader can be used and optimized for the procurement and transfer of digital text documents.

The presented system for the procurement and display of digital text documents is completed by a novel mobile unit presented here that is especially designed for the display of text.

The components employed in the mobile unit are shown in FIG. 2 and described below in more detail.

### Display (21):

Display technology employed in the mobile unit can be any technology applicable for the display of text. The main goals of the invention, namely energy efficiency and reduction of production cost, can be achieved by using electrophoretic displays, also referred to as electronic paper or E-Ink displays. Such displays can hold text and images indefinitely without using electricity, only when changing the displayed content (i.e. when turning a page) a charge is applied. Power consumption of E-ink displays is considerably low making them the preferred technology to be used in the presented mobile unit.

### Input Elements (22):

User interaction can be realized by equipping the mobile unit with adequate keys or buttons, preferably there are only two for paging forward or backward. Other user input might be necessary for turning the device on and off (ideally, no power switch is needed as an E-ink display in its basic state is off unless a page turn occurs) or establishing a bluetooth connection. Therefore additional buttons or keys might be implemented. It can also be made possible without additional keys by assigning different input instructions to different manners in which the paging buttons can be pressed (long, short, both keys at the same time etc.).

It is also conceived to implement a touchscreen or touchpad to receive user input which would further refine the distinction of user interactions.

### CPU and Display Controller (23):

Data processing (e.g. receipt of documents, handling of user input) is carried out by a microcontroller that integrates (or communicates directly with) a display controller.

If an electrophoretic display is used the mobile unit does not need to be switched off by the user as it consumes no energy as long as the displayed content does not change. Due to this fact no operating system is required for running the mobile unit. Therefore booting or rebooting the device is not necessary, it can be used immediately, again saving time and energy.

### Memory (24, 25):

The mobile unit contains a memory component, preferably as part of a low cost CPU (24) that provides the code that needs to be executed for loading, decompressing and displaying of received text documents. In addition, a unique user or device ID can be saved in order to explicitly identify the device and to allow for copyright protection as mentioned above.

Another memory component (25) can be included for storing several received image files before they are displayed on the device. This device can be for example an internal or removable SD card.

### Energy Supply (26):

Simplest implementation of an energy source can be alkaline batteries, a capacity or preferably a rechargeable battery. To recharge a battery a connection for power supply is provided either via cable or cordless through magnetic induction. Preferably, the mobile unit is equipped with solar cells that recharge the battery or serve for direct energy supply.

### Data Interface (27):

Data (i.e. text documents resp. image files) are transmitted from the base station to the mobile unit via an appropriate interface. Possible technologies include wired parallel or serial interfaces or radio links (e.g. WLAN or Bluetooth).

### Case Design:

Preferably, the provided mobile unit exhibits no physical ports (keys, interfaces etc.) leading to a sealed case design that allows the usage of the device in dusty, sandy or wet environment.

### Example of Use

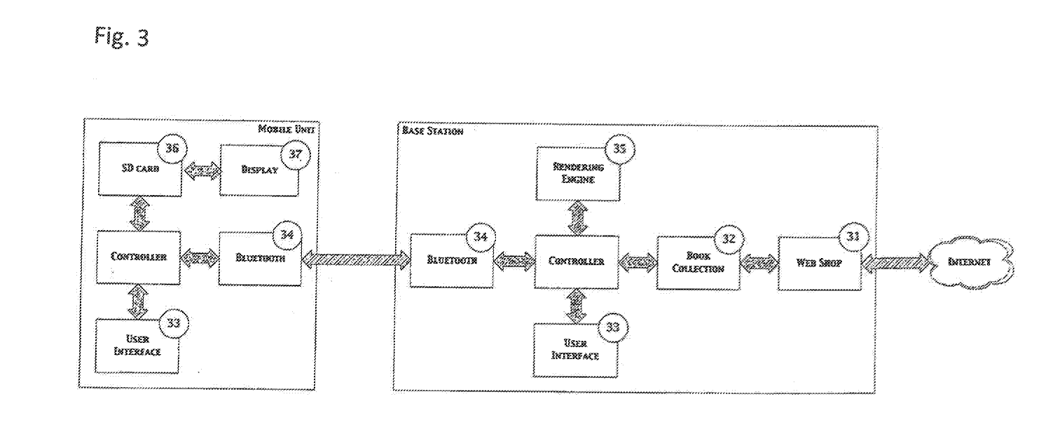

FIG. 3 highlights the document flow through the provided infrastructure.

The user possesses a base station that is connected to the internet and a mobile unit as described above. Base station and mobile unit are both linked to the same user ID that has been assigned to the user. The user operates base station and mobile unit by the means of the respective user interfaces (33). Via the base station the user accesses a web shop (31) where he can buy a book that is then added to the book collection (32). The e-book is formatted as epub-file. Through the user interface (33, e.g. buttons) on the mobile unit, the user initiates the bluetooth communication between mobile unit and base station. Before the book is transferred to the mobile unit, ist is rendered (35) on the base station and if necessary licenced to the user ID of the devices. After rendering and licensing the book the pages are transferred to the mobile unit and stored in its memory (36) and displayed (37).

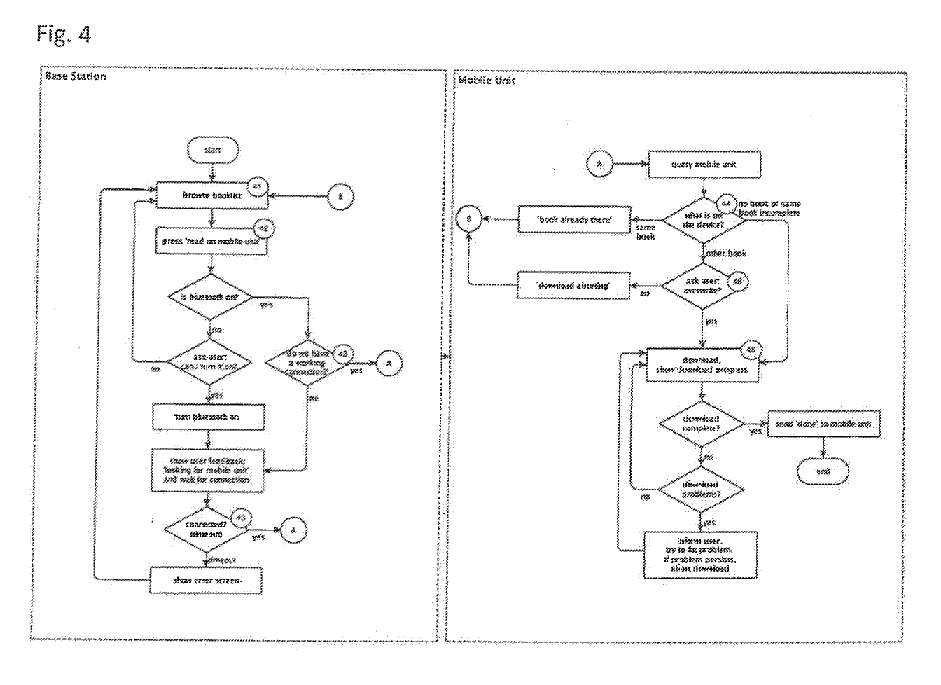

FIG. 4 represents an exemplary flow of user interactions and operations carried out on the base station and the mobile unit before a book is displayed:

After the user has stored the epub-file on the base station it is accessible for example via a booklist (41). The user can start an application that enables the transfer to the mobile unit and serves for the fulfilment and rendering process. By choosing “read on mobile unit” (42) the base station tries to connect to the mobile unit and initiates the downloading process (A) if a working connection could be established (43). Before the download is carried out, the content of the mobile device is checked (44). If the selected book is already on the device (“same book”) it is not downloaded (B). If there is no book on the device or if the same book is on the device in incomplete form the missing pages are downloaded (45). If one ore more further books are already on the device and the memory is insufficient to keep all the books then the user is asked to approve the overwriting of one or more books (46) before the download starts.

During the rendering process each page of the document is converted into an image file. The user can for example determine the font size in which the document is rendered. Subsequently the image files are transmitted from the base station to the mobile unit via a Bluetooth port.

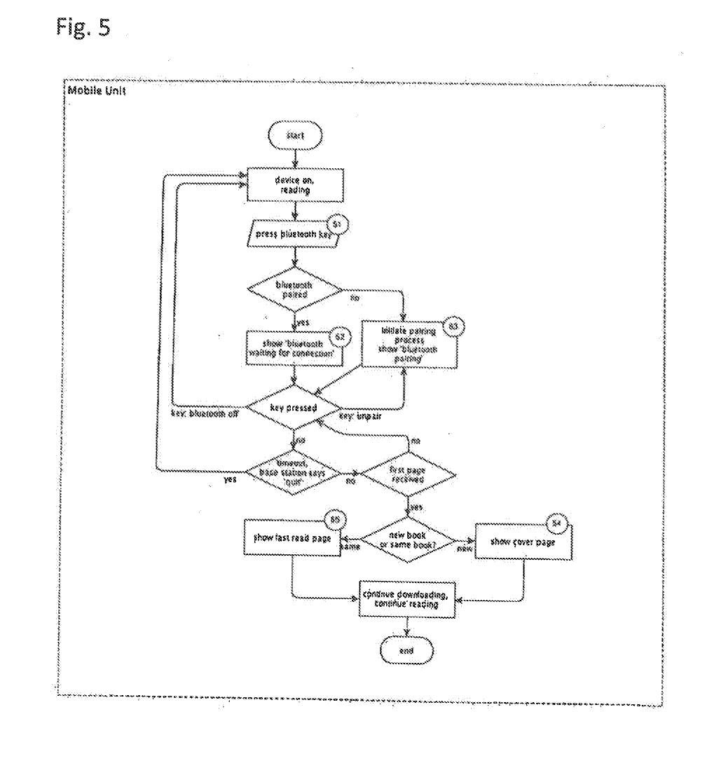

FIG. 5 illustrates an exemplary process flow of establishing a radio (bluetooth) connection to the base station. The bluetooth interface of the mobile device is initiated when pressing a specified key or combination of keys (51). If the device is already paired (52) with the base station the connection is working. Otherwise, a pairing process between base station and mobile unit has to be initiated (53) in order to establish a working connection to realize book downloads etc.

The first page of a new document is immediately shown on the display of the mobile unit (54). All other pages are stored on the memory of the mobile unit and are displayed when the user requests a page-turn by pushing a key or swiping over the touchscreen of the mobile unit. If the user continues reading an existing book the last page is displayed (55).

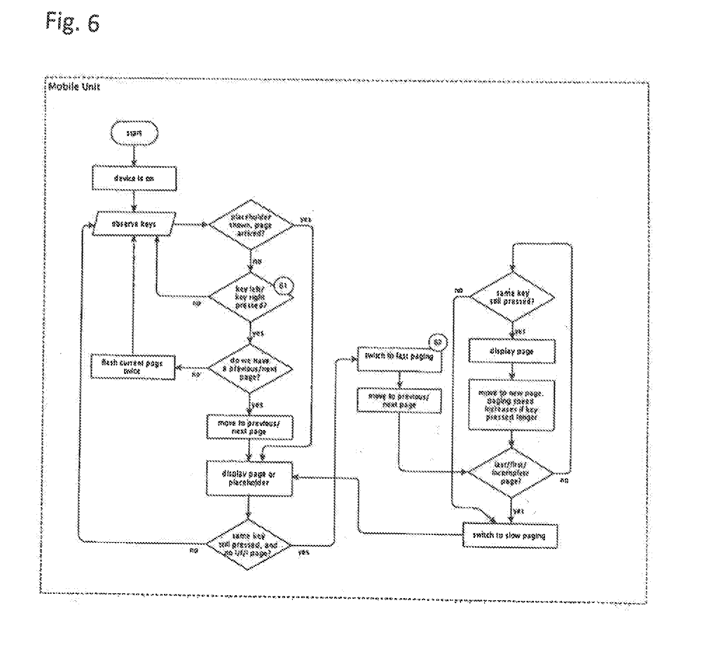

FIG. 6 shows an exemplary flow of operations carried out on the mobile unit when reading and paging through a text. In this mode the mobile unit can be used independently from the base station.

The two paging keys enable paging to the next or previous page (61). Preferably, the paging keys can offer different paging speed (62). For example: pressing the key once will initiate a page turn, if the key is kept pressed after the page turn, fast paging is initiated in which the pages are being turned until the key is released. Fast paging can also be initiated when a key is held for a certain time, e.g. longer than one second.

In the simplest configuration the mobile unit offers no menu function. In this case the device can only display one book and one page after the other. In order to read another book, the memory is to be overwritten when transmitting the new book from the base station to the mobile unit.

An application can also be provided to realize a remote menu function on the base station. On the display of a PC or a smartphone a graphic user interface (GUI) can be shown that corresponds to the functions of the mobile unit. Inputs to this GUI lead to a transmission (e.g. via short range radio) of the corresponding instructions to the mobile unit where they are executed.

1. A comprehensive system for procuring and displaying digital text documents on a mobile device comprising the following components:
mobile unit, designated for the display of electronic text documents comprising
display
memory
microcontroller/display-controller
interface to the base station
energy source
base station, comprising at least
data interface
data storage
data processing unit
interface to the mobile unit
energy source
wherein a document is received by the base station via a data interface, stored in the data storage of the base station and document pages are converted in the data processing unit of the base station to a file format that is displayable by the mobile unit where it is sent to via an interface to be displayed on the mobile unit.

2. A system as described in claim 1 wherein the mobile unit is linked to a unique ID to enable licensing and access provisions of the documents that are to be displayed.

3. A system as described in claim 1 wherein the mobile unit contains an electrophoretic display.

4. A system as described in claim 1 wherein the mobile unit contains a touch sensitive display (touchscreen).

5. A system as described claim 1 wherein the mobile unit contains a non-volatile memory to store one or more documents.

6. A system as described in claim 1 wherein the data interface between base station and mobile unit is of wireless technology and data is transmitted via radio from the base station to the mobile unit.

7. A process carried out by the means of the infrastructure as described in claim 1 wherein a document is received by the base station via a data interface, stored in the data storage of the base station and document pages are converted in the data processing unit of the base station to a file format that is displayable by the mobile unit where it is sent to via an interface to be displayed on the mobile unit.

8. A process described in claim 7 wherein files that are to be transmitted from the base station to the mobile unit are compressed before transmission.

9. A process described in claim 7 wherein files that are to be transmitted from the base station to the mobile unit are encrypted before transmission and decrypted on the mobile unit.

10. A process described in claim 7 wherein navigation on the mobile unit is established via a remote user interface on the base station.
